(19) United States
(12) Patent Application Publication
(10) Pub. No.: US 2005/0111574 A1
(43) Pub. Date: May 26, 2005

(54) Transmission device with digital predistortion, and method for regulating predistortion in a transmission device

(76) Inventors: Jan-Erik Muller, Ottobrunn (DE); Nazim Ceylan, Munchen (DE)

Correspondence Address: ESCHWEILER & ASSOCIATES, LLC;NATIONAL CITY BANK BUILDING, 629 EUCLID AVE., SUITE 1210, CLEVELAND, OH, 44114, US

(21) Appl. No.: 10/952,316

(22) Filed: Sep. 28, 2004

(30) Foreign Application Priority Data
Sep. 30, 2003 (DE) DE 103 45 517.5

(51) Int. Cl. H04K 1/02

(52) U.S. Cl. 375/296

(57) ABSTRACT

One or more aspects of the present invention relate to a transmission device having a digital predistortion unit which has a control input to which a control signal (CONT1) is applied. The control signal is output by a power control unit which evaluates a power control signal (LS). The predistortion unit distorts a baseband signal which is to be transmitted whenever the linearity of a power amplifier can no longer be observed at the currently required power without predistortion. To this end, the baseband signal is multiplied in complex fashion by a predistortion coefficient which is dependent on the level of the baseband signal.

### REFERENCE TO RELATED APPLICATIONS

This application claims the benefit of the priority date of German application DE 103 45 517.5, filed on Sep. 30, 2003, the contents of which are herein incorporated by reference in their entirety.

### FIELD OF THE INVENTION

The invention relates to a transmission device with digital predistortion, particularly for mobile communication appliances, and also to a method for regulating predistortion for a discrete-value signal in a transmission device comprising an amplification device.

### BACKGROUND OF THE INVENTION

Modern mobile radio standards such as UMTS or WLAN require the use of bandwidth-efficient modulation types such as QPSK or QAM (Quadrature Amplitude Modulation), for example. The modulation types use an amplitude-modulated signal, so that the level of the signal varies over time. This requires particularly high demands on linearity for the transmission path in order to keep transmission errors in output signals having high levels as small as possible. The transmission path therefore requires a power amplifier at the output which attains the highest possible level of linearity over a wide range. At the same time, it should have a low power consumption, since power amplifiers in wireless communication appliances have a large share of the total power consumption. However, a high level of efficiency for a power amplifier, that is to say a high ratio of generated RF power to required power, is usually achieved in a range in which the RF transfer characteristic of the power amplifier has high levels of nonlinearity. Good linearity for the power amplifier can be achieved at low efficiency, that is to say when the output power is low in comparison with the power amplifier's required DC power.

In order to reduce transmission errors as a result of nonlinearities in the power amplifier in the transmission path, predistorted input signals are used for the power amplifier. These signals are predistorted such that the nonlinear output characteristic of the power amplifier is compensated for by the predistortion. This allows a high output power for simultaneously low power consumption in the power amplifier, without the resultant nonlinearities modifying the output signal unreasonably.

In mobile communication appliances today, power amplifiers are used which attempt to achieve the best possible compromise between linearity and power consumption through ordinarily suitable circuitry. One example of this can be found in the printed document by Iwai et al, “High Efficiency and High Linearity InGaP/GAs HBT Power Amplifiers: Matching Techniques of Source and Load Impedance to Improve Phase Distortion and Linearity”, IEEE Transactions On Electron Devices, vol. 45, No 6, June 1998.

A further improvement in linearity can be provided using further additional circuits. Two examples of predistortion of an analog signal which is applied to the input of the power amplifier are given in the printed documents E. Westesson et al.: “A Complex Polynomial Predistorter Chip in CMOS for Baseband or IF Linearization of RF Power Amplifiers”, IEEE International Symposium on Circuits and Systems, 1999, and in Yamauchi et al., “A Novel Series Diode Linearizer for Mobile Radio Power Amplifiers, IEEE MTT-S Digest”, 1996, pages 831 to 833. However, a drawback of such analog predistortion circuits is the extremely narrow boundaries for external operating conditions of the circuit, such as temperature, actuation or operating point. If these constraints change, it is necessary for the analog predistortion circuit to be flexibly adjusted. Flexible adjustment of an analog predistortion circuit is possible only with a high level of complexity, however.

In contrast to the predistortion of the analog baseband signal, predistortion of the digital baseband signal has the advantage of being able to be matched to changing external operating conditions. Circuits and methods for digital predistortion, above all for power amplifiers in base stations, are described in U.S. Pat. Nos. 6,477,477 and 4,291,277. These use “adaptive implementation” so as to output a portion of the amplified signal and measure the signal distorted by the base station's power amplifier. From this, they calculate the predistortion coefficients, which are logically combined with the digital baseband signal. The computation power and additional components required for this result in a high level of circuit complexity, however. In addition, the power consumption of the circuits is very high since the digital data stream is predistorted continuously, meaning that direct transfer of the circuits described to mobile communication appliances does not appear expedient.

### SUMMARY OF THE INVENTION

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present one or more concepts of the invention in a simplified form as a prelude to the more detailed description that is presented later.

According to one or more aspects of the present invention, a transmission device is provided which produces a sufficiently high level of linearity at a relatively high efficiency. Additionally, a method of regulating predistortion is also disclosed whereby power consumption is significantly reduced.

A transmission device has a processor unit for providing a baseband signal according to one or more aspects of the present invention. The baseband signal has a first discrete-value component and a second discrete-value component. These are provided at a first output and at a second output on the processor unit. The first output of the processor unit is operatively associated with the first input of a predistortion unit, and the second output is operatively associated with a second input on a predistortion unit. The predistortion unit contains a coefficient unit for ascertaining a predistortion coefficient. The predistortion coefficient is a complex value. In this context, the complex predistortion coefficient is dependent on a control signal at the control input and on the first component applied to the first input and the second component applied to the second input. The predistortion unit also contains a multiplication unit for complex multiplication. The unit is designed to output a derived output signal having a first discrete-value component to a first output and a second discrete-value component to a second output from the first and second discrete-value components of the baseband signal applied to the first and second inputs. The predistortion unit has a first and a second operating state. In the first operating state it is designed to output the undistorted baseband signal at its outputs, and in the second operating state it is designed to output the derived output signal. In addition, the transmission device has respective digital/analog conversion devices operatively associated with the two outputs of the predistortion unit. The output of a first digital/analog conversion device is operatively associated with a first input for supplying a first continuous-value signal to a modulator unit, and the output of the second digital/analog conversion device is coupled to a second input for supplying a second continuous-value signal to a modulator unit. In addition, the modulator unit contains a local oscillator input for supplying a local oscillator signal and an output for outputting a complex-form output signal. The modulator unit converts the two continuous-value components into the complex-form output signal using the local oscillator signal. In addition, the transmission device contains an amplification device with a gain which can be regulated on an analog or digital basis, whose input is operatively associated with the output of the modulator unit. Finally, the transmission device has a power control unit with an input for supplying a discrete-value power control signal. The power control signal is output by the processor unit. The power control unit provides a first control signal at a first output and a second control signal at a second output. The second output of the power control unit is coupled to the control input of the predistortion unit, and the first output of the power control unit is coupled to a control input on the amplification device. In addition, the predistortion unit can be switched to one of the two operating states by the control signal at the control input.

The transmission device thus represents a circuit which is designed for digitally predistorting a baseband signal without a feedback path. The predistortion unit distorts an applied baseband signal on the basis of the control signal at its control input. The control signal is provided by the power control unit, which thus controls the power of the output signal from the regulatable amplification device. At the same time, a second amplification device (e.g., a power amplifier) operatively associated with the output of the regulatable amplification device is operated in the range of a high level of efficiency. As a result, it outputs a signal at high power with low power consumption. If the level of the signal applied to the input of the second amplification device is too high, the predistortion unit performs suitable predistortion in order to compensate for the distortion in the second amplification device which is brought about by the high input level. If the level of the output signal is such that the RF transfer characteristic has sufficient linearity, the predistortion unit is switched to the first operating state by the control signal, and the baseband signal remains undistorted. This means that a good level of linearity in the output signal is always ensured. The level of the output signal which is to be transmitted is known to the processor unit, which means that the processor unit uses a suitable power control signal to determine the first control signal for the predistortion unit and the second control signal for the regulatable amplification device.

The baseband signal applied to the input side of the predistortion unit is predistorted by the unit such that, having passed through all downstream elements of the transmission device, it represents a linear map of the desired signal which is to be transmitted. The nonlinearities present in the transmission path are thus compensated for in a suitable manner.

This allows the power amplifier to be smaller than conventional comparable devices. In the range of a high level of efficiency, in which nonlinearities arise particularly in the power amplifier, these nonlinearities are compensated for by the predistorted signal. When the linearity demand for the output signal is no longer be observed, the predistortion unit predistorts an applied signal as controlled by the power control unit. This allows the power consumption to be significantly reduced once more.

In an exemplary method for regulating predistortion for a discrete-value signal in a transmission device comprising an amplification apparatus, predistortion is carried out when a level for the output signal from the regulatable amplification device is exceeded. In this case, the level of the output signal is determined by the control signal which is output by the power control unit. The predistortion is performed by complex multiplication of the first and second discrete-value components of the baseband signal by a complex predistortion coefficient which is dependent on the level of the first and second discrete-value components of the baseband signal and on the control signal.

Hence, predistortion is merely performed when the level of the signal which is to be amplified exceeds a defined limit value. This limit value is the level value after which the output characteristic of the transmission device has a highly nonlinear profile, that is to say the input level for the amplification device becomes too high.

In one example, an output on the amplification device with regulatable gain has a connection to a further amplification device, which has a fixed gain factor. The amplification device with regulatable gain is therefore in the form of a preamplifier for the further amplification device. The predistortion unit is designed to predistort a baseband signal, such that a nonlinear output characteristic, which arises in the further amplification device, is compensated for. Alternatively, the modulator unit also has various gain levels.

In another example, at least one sensor circuit for detecting changes in operating conditions in the transmission device is provided. The sensor circuit is also designed to generate signals derived from the operating conditions at an output which is coupled to a second control input on the predistortion unit. In this configuration, a transmission device having an adaptive predistortion circuit is produced. Changing external operating conditions, such as temperature, operating voltage, modulation, are detected by the sensor circuit and are converted into a control signal which suitably influences the predistortion of components of the baseband signal which are applied to the input of the predistortion unit.

In another example, the predistortion unit is designed to distort a signal with an inverse signal transfer function from at least one circuit located downstream of the distortion unit. As a result, the predistortion unit maps a nonlinear signal transfer function for the downstream circuit chain. The distortions caused by the downstream circuit elements are therefore compensated for by the predistortion unit, so that an undistorted signal can be tapped off at the output of the transmission device.

In yet another example, the coefficient unit for ascertaining the predistortion coefficients comprises a memory device containing stored predistortion coefficients, and also an address calculation unit. The address calculation unit generates an address signal for a predistortion coefficient stored in the memory unit from the level of the first and second discrete-value components of the baseband signal and from the first control signal. The memory device is designed to provide the complex predistortion coefficient determined by the address signal to the multiplication unit.

In a further example, the processor unit is designed to provide a baseband signal whose first component represents an inphase component and whose second component represents a quadrature component. Such a baseband signal is therefore an I/Q signal which has two mutually orthogonal components. In an alternative configuration, the first component of the baseband signal represents an amplitude and the second component of the baseband signal represents a phase.

In still another example, the discrete-value signal has two components, with a level for the discrete-value signal being determined by the square of the magnitude of the two components. Hence, the levels of the two components are squared and added. The result is the square of the magnitude. An alternative is the simple magnitude of the complex signal with the two components expressed by the root of the square of the magnitude. If the components of the baseband signal are represented in polar form, that is to say in amplitude and phase, then the required level is determined solely by the amplitude component.

In another example, the predistortion coefficient is selected from a set of stored predistortion coefficients. In this case, the selection is preferably made by control signals. In a further design, sensor circuits in the transmission device ascertain changing operating conditions in the amplification device, and signals are derived therefrom. Predistortion is performed using at least one predistortion coefficient which is dependent on the derived signals. As a result, predistortion coefficients are selected and are used to distort the signal such that the changes in the operating conditions compensate for one another.

In one example, the predistortion coefficients used for predistorting the discrete-value signal represent an inverse signal transfer function at least for the amplification device. Hence, a signal transfer function can be represented by predistortion coefficients.

### BRIEF DESCRIPTION OF THE DRAWINGS

The invention is explained in more detail below wherein reference is made to the following drawings.

FIG. 1 is a circuit schematic illustrating an exemplary transmission device according to one or more aspects of the present invention.

FIG. 2 is a circuit schematic illustrating an exemplary predistortion unit that may be included within a transmission device, such as that presented in FIG. 1, according to one or more aspects of the present invention.

FIG. 3 is a circuit schematic illustrating an exemplary address calculation unit that may be included within a predistortion unit, such as that presented in FIG. 2, according to one or more aspects of the present invention.

FIG. 4 is a circuit schematic illustrating an exemplary multiplication unit that may be included within a predistortion unit, such as that presented in FIG. 2, according to one or more aspects of the present invention.

FIG. 5 is a graphical depiction illustrating exemplary plots of respective amplitudes of a component of an undistorted baseband signal (DAT1) and an associated distorted baseband signal (DAT2) over the course of time according to one or more aspects of the present invention.

FIG. 6 is a graphical depiction of a frequency spectrum whereon exemplary plots of an output signal are respectively illustrated for undistorted and distorted baseband signals.

FIG. 7 is a circuit schematic illustrating another exemplary transmission device according to one or more aspects of the present invention.

### DETAILED DESCRIPTION OF THE INVENTION

The present invention pertains to a transmission device. One or more aspects of the present invention will now be described with reference to drawing figures, wherein like reference numerals are used to refer to like elements throughout. It should be understood that the drawing figures and following descriptions are merely illustrative and that they should not be taken in a limiting sense. In the following description, for purposes of explanation, numerous specific details are set forth in order to provide a thorough understanding of the present invention. It will be evident to one skilled in the art, however, that the present invention may be practiced without these specific details. Thus, it will be appreciated that variations of the illustrated systems and methods apart from those illustrated and described herein may exist and that such variations are deemed as falling within the scope of the present invention and the appended claims.

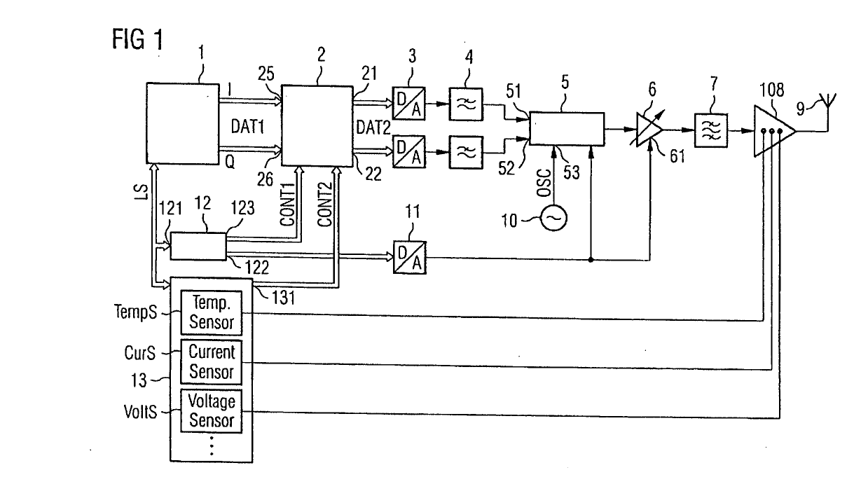

Turning to FIG. 1, a circuit schematic illustrates an exemplary transmission device according to one or more aspects of the present invention. The transmission device is operable to, among other things, predistort a signal to be transmitted in a digital range, convert the signal into an analog signal, amplify the signal and then transmit it via an antenna.

To this end, a processor unit 1 is provided. This takes the internal data which are to be transmitted and generates, at its output, a complex baseband signal DAT1 which has two components I and Q. The two outputs of the processor unit are connected to the inputs 25 and 26 of a predistortion unit 2. At the two outputs 21, 22 of the predistortion unit 2, it is possible to tap off the components I2 and Q2 of the signal DAT2 derived from the signal DAT1 which is applied to the input side. The two outputs 21 and 22 are connected to a digital/analog converter 3 whose outputs are connected via a lowpass filter 4 to the inputs 51, 52 of a vector modulator 5.

In addition, the vector modulator 5 has a local oscillator input 53 to which the local oscillator signal OSC from an oscillator 10 is applied. The vector modulator 5 uses the local oscillator signal OSC to convert signals applied to its two inputs into an output signal and outputs this signal at its output 54. In addition, it contains a control input for supplying a control signal which regulates the output power of the signal at the output 54. The output 54 of the vector modulator 5 is connected to the input of a regulatable amplifier 6. The amplifier 6 is a voltage controlled amplifier which can be regulated on an analog basis and has a control input 61. Its output is connected via a bandpass filter 7 to the input of a power amplifier 8 which has a fixed gain. The output of the power amplifier 8 is connected to an antenna 9.

The processor unit 1 also has a control output which is connected to a power control unit 12 and to a sensor device 13. The sensor device 13 contains three sensors: a temperature sensor TempS, a current sensor CurS and a voltage sensor VoltS. These measure the operating parameters temperature, current drawn and actuation of the power amplifier 8. Apart from the measured data, the sensor device 13 generates a control signal CONT2 at its output 131, and this control signal is supplied to a control input on the predistortion unit 2.

The power control unit 12 contains an input 121, which is connected to the control output of the processor unit 1, and two outputs 122 and 123. The output 122 is connected via a digital/analog converter 11 to the control input of the vector modulator 5 and to the control input 61 of the regulatable amplifier 6. The output 123 of the power control unit 12 is connected to the first control input of the predistortion unit 2.

From the information which is to be transferred, the processor unit 1 generates discrete-value signals I and Q, which together form the baseband signal DAT1, at its two outputs. The two components I and Q represent the inphase and quadrature components of a complex baseband signal. At the same time, the processor unit 1 outputs a power control signal LS at its control output, and this power control signal transmits the gain which is to be set to the power control unit 12.

At its output 122, the power control unit 12 outputs a first discrete-value signal, which is converted by the digital/analog converter 11 into an analog control signal and is supplied to the control input of the vector modulator 5 and to the control input 61 of the amplifier device 6. These control signals regulate the gain of the vector modulator 5 and of the amplification device 6. As a result, signals with different levels are applied to the input of the amplification device 8 on the basis of the control signal. These signals are amplified by the amplification device 8 using a fixed gain factor, so that the radiated output power on the antenna 9 corresponds to the transmission power which is desired by the processor unit 1.

At the same time, the power control unit 12 outputs a control signal CONT1 at the second output 123. This control signal is used by the predistortion unit 2 in order to select a complex predistortion coefficient from a set of stored predistortion coefficients, said selected coefficient being intended to be used for predistorting the two components I and Q of the baseband signal DAT1 applied to the input side. The predistortion coefficients used map the inverse signal transfer function of the circuit chain, starting at the DA converters 3 via the low pass filter 4, the vector modulator 5 through the second amplification device 8. As a result, the baseband signal DAT1 is predistorted such that the signal which can be tapped off at the output of the amplification device 8 corresponds to the undistorted baseband signal again. In this case, the amplification device 8 normally provides the largest contribution to the whole distortion.

The predistortion unit 2 is designed such that it also outputs the baseband signal DAT1 in undistorted form at the output on the basis of the control signal CONT1. The baseband signal DAT1 needs to be predistorted only when the linearity of the transfer characteristic of the entire amplifier chain, starting at the D/A converter 3 through to the amplification device 8, is no longer sufficient at the desired power of the output signal. However, this is the case only when the output power of the transmission device is intended to be very high, that is to say the signal levels of the output signals from the vector modulator 5 and from the amplification device 6 are very high. In such a case, the amplification device 8 amplifies the signal applied to the input with a nonlinear characteristic, and the output signal is distorted. The predistortion compensates for the distortion by the amplifier 8.

In this case, the power which is to be transmitted is known to the processor 1. Particularly in modern communication standards such as WCDMA, the transmission powers are communicated to the mobile appliance. This is typically done approximately 1000 times per second. The processor 1 therefore sets the maximum radiation power to be transmitted on the antenna using the control signal until there is another change. The required level of the input signal can therefore be calculated from the fixed gain factor of the amplifier 8. This level is communicated to the power control unit by the power control signal, and the power control unit transmits the corresponding control signal. In addition, it is ascertained whether the baseband signal needs to be predistorted during this time (e.g., because the input level is above a limit value and/or the nonlinear distortions produced in the amplifier 8 are reducing the signal quality of the transmitted signal too greatly).

Since the output characteristic of the amplification device 8 is also dependent on further external operating parameters, the control signal CONT2 is also provided, which is likewise used by the predistortion unit 2 in order to select the predistortion coefficients.

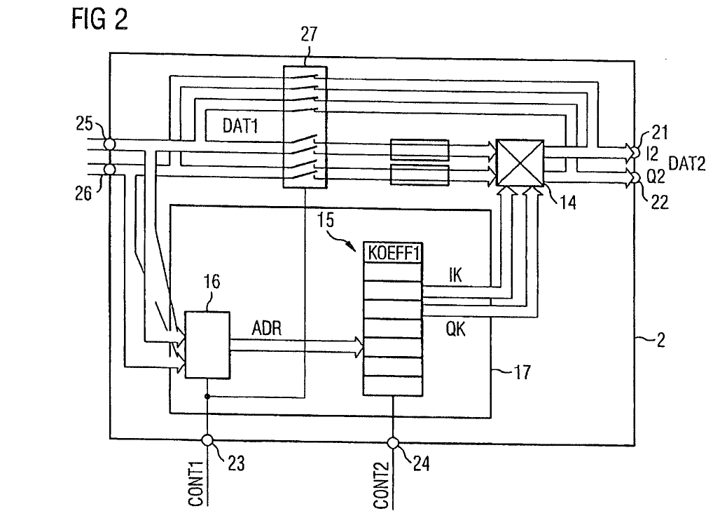

Turning to FIG. 2, a circuit schematic illustrates an exemplary predistortion unit that may be included within a transmission device, such as that presented in FIG. 1, according to one or more aspects of the present invention. The undistorted discrete-value baseband signal DAT1 with its component I and its component Q is supplied both to an address calculation unit 16 and to a switching unit 27. The switching unit 27 has a control input which is connected to the input 23 of the predistortion unit and is provided for the purpose of supplying the control signal CONT1. In one switch position, it connects the inputs 25 and 26 directly to the outputs 21 and 22. This is done when the predistortion unit has been deactivated by the control signal CONT1, that is to say the baseband signal is not intended to be predistorted. The baseband signal applied to the inputs is output in unaltered form at the outputs again, and the predistortion unit and particularly a complex multiplier 14 which is now deactivated and does not draw any current are thus bridged.

When the control signal CONT1 signals predistortion, the predistortion unit is activated and the control circuit 27 is switched such that it connects the inputs 25 and 26 to the complex multiplier 14 via a delay element (not shown). The delay in the element is equal to the time which is required for calculating the predistortion coefficients.

In addition, the address calculation unit 16 has a control input which is likewise routed to the input 23 of the predistortion unit. The address calculation unit 16 takes into account not only the control signal CONT1 but also the amplitude or the levels of the two components I and Q of the digital baseband signal when the predistortion coefficients are determined.

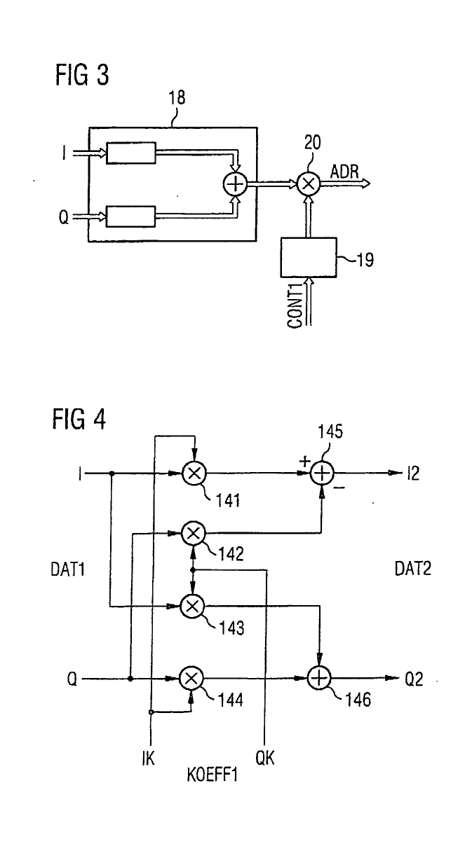

FIG. 3 is a circuit schematic that illustrates an exemplary address calculation unit that may be included within a predistortion unit, such as that presented in FIG. 2, according to one or more aspects of the present invention. The address calculation unit has two squaring elements 18 which are respectively used to form the square of the magnitude of the I and Q components of the baseband signal. In this case, the square of the magnitude is obtained from the sum of the squares of the individual components. The result is part of an address signal ADR which is additionally scaled using the control signal. To this end, the address calculation unit 16 contains a control circuit 19 which evaluates the control signal CONT1. The signal derived therefrom is scaled together with the amplitude of the baseband signal using a multiplier 20 and produces the address signal ADR.

This address signal is supplied to a memory matrix 15. The memory matrix 15 contains a plurality of sets of predistortion coefficients which take into account both external operating parameters and the signal level. Using the address signal ADR and the control signal CONT2, which contains information about the operating parameters, a complex predistortion coefficient KOEFF1 having two components IK and QK is selected from the memory matrix 15 and is supplied to the complex multiplier 14.

The address calculation unit therefore generates the address signal for providing the complex coefficient in a simple manner. The memory unit merely represents a table having a plurality of columns. The column is chosen by the control signal CONT2, and the row with the complex coefficient KOEFF1 is chosen by the address signal. The control signal CONT1 is used merely for scaling. If the total level of the components I and Q has 8 possible settings, for example, then 256 predistortion coefficients are obtained therefrom. The total level is scaled with the control signal CONT1, so that a cohesive range is thus selected from the 256 coefficients. One of these coefficients is used for the present calculation of the predistortion. By way of example, the scaling factor using the control signal CONT1 has the value 0.8. The range of the selected coefficients thus extends from the 1st to the 204th coefficient. For a present level, one of these coefficients is used for the predistortion. The predistortion coefficient is supplied to the complex multiplier unit 14.

The coefficients may to some extent also be obtained through extrapolation and/or interpolation, so that the total number is reduced. This applies particularly to additional columns whose values are determined by the control signal CONT2 and take into account external, changed operating conditions. In this case, it suffices merely to take into account the amplitude of the complex baseband signal, since the phase does not cause any distortion. The phase distortion in the amplifier is taken into account by the complex coefficient and the multiplier 14.

FIG. 4 is a circuit schematic that illustrates an exemplary multiplication unit that may be included within a predistortion unit, such as that presented in FIG. 2, according to one or more aspects of the present invention. The multiplier 14 contains four scalar multipliers 141, 142, 143 and 144 and also an adder 146 and a subtractor 145. The scalar multiplier 141 multiplies the component I by the coefficient component IK, and the scalar multiplier 143 multiplies the component I by the coefficient component QK. The baseband component Q is multiplied by the coefficient component QK by the scalar multiplier 142 and by the coefficient component IK by the scalar multiplier 144. On the output side, the scalar multipliers 141 and 142 are connected to a subtractor 145 which subtracts the output signal from the scalar multiplier 142 from the output signal from the scalar multiplier 141 and outputs it as component I2 of the distorted baseband signal DAT2. The output of the adder 146, which adds the output signals from the scalar multipliers 143 and 144, carries the distorted component Q2 of the baseband signal DAT2. The circuit of the multiplier 14 thus multiplies the signal DAT1, which represents a complex baseband I+jQ, by the complex predistortion coefficient KOEFF1. The multiplier 14 thus takes into account a phase distortion and predistorts the phase of the baseband signal in a suitable manner.

The multiplier 14, the memory unit 15 and the address calculation unit 16 can be turned off. This reduces the power consumption of the predistortion unit when no predistortion is required. The control signal CONT1 can be used to switch the predistortion unit to an active operating state, in which the I and Q components of the baseband signal are predistorted, or to an inactive operating state, in which the switch 27 outputs an input signal in undistorted form at the output.

FIG. 5 shows the amplitude of a component of the undistorted baseband signal DAT1 and also the associated distorted baseband signal DAT2 over the course of time. The distorted baseband signal is converted to an output frequency in the vector modulator 5, is amplified again and is supplied to the amplification device 8, which amplifies the signal such that the distortions are compensated for again by the nonlinear gain of the amplification device 8.

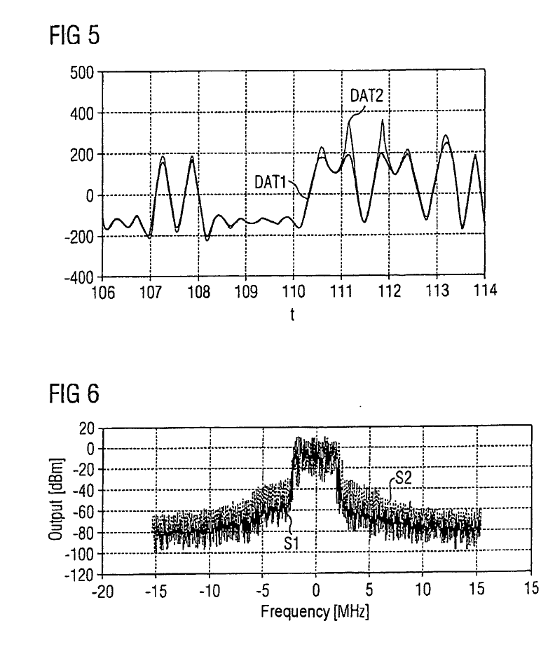

Distortions brought about by a nonlinear transfer characteristic produce intermodulation products in an amplification device, which appear as additional lines in the spectrum. In a broad useful-signal spectrum, this is manifested by virtue of additional power being generated next to the actual useful channel, said additional power being referred to as “adjacent channel power”. The predistortion significantly suppresses intermodulation products, so that the adjacent channel power is also reduced. Such a reduction can be seen in FIG. 6, which is a graphical depiction of a frequency spectrum whereon exemplary plots of an output signal are respectively illustrated for undistorted and distorted baseband signals. In this case, the spectrum of a modulated output signal is visible. In this context, the spectrum S1 is a useful signal whose baseband signal has been distorted in a suitable manner, and the spectrum S2 is the same useful signal with an undistorted baseband signal. It can clearly be seen that the digital predistortion has significantly reduced the intermodulation products and hence the adjacent channel power.

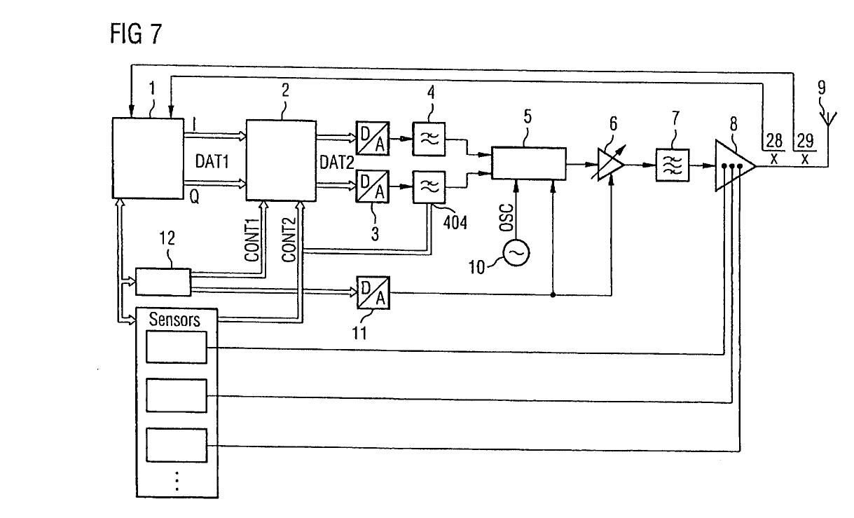

FIG. 7 is a circuit schematic illustrating another exemplary transmission device according to one or more aspects of the present invention. In this example, components which have the same function or action have the same reference symbols. In this exemplary embodiment, two directional couplers 28 and 29 are provided which are connected to the output of the power amplifier 8 and between power amplifier 8 and antenna 9.

The two directional couplers 28 and 29 ascertain the amplitude magnitude and also the phase of a signal which is output by the power amplifier 8, and also the amplitude magnitude and the phase of a signal which is reflected by the antenna 9. The parameters are supplied to the processor 1 for producing predistortion for the baseband signals I and Q.

Such a design is advantageous, since the properties of the transmission stages in mobile communication appliances are heavily dependent on the antenna impedance. Environmental influences, such as metal or dielectric objects in the close surroundings of the antenna, mean that the antenna impedance is frequently uncontrollably different than the normal antenna impedance. Such an alteration in the antenna impedance has a direct effect on the output of the power amplifier 8, which now additionally produces distortions in the output signal on account of the resultant mismatch.

To mitigate such distortions and to achieve decoupling between the power amplifier 8 and the antenna 9, a circulator may also be used, inter alia. This is relatively expensive, however, and normally cannot be integrated monolithically on a semiconductor body. In addition, it produces noticeable losses which restrict the efficiency of the transmission stages.

The illustrated design with a directional coupler or a detector for detecting an impedance change allows the complex load reflection factor of the transmission output stage to be detected adaptively in suitable fashion and hence allows the predistortion to be influenced such that the demanded linear signal response is present on the antenna 9. In particular, it is possible to compensate partially for an incorrect match which results in distortion of the output signal from the amplifier 8. Since the impedance change in the antenna takes place relatively slowly, the processor and the baseband signal generator 1 have sufficient time to select suitable predistortion coefficients.

However, it should be taken into account that predistorting the digital baseband signal results in a broader frequency spectrum. For this reason, the low pass filters 4 need to be suitably adapted, so that additional phase distortion does not arise on account of too small a filter bandwidth. This can be achieved by a filter changeover system which changes over the bandwidth according to active or inactive digital predistortion. In the illustrated example, changeover filters 4 are provided whose actuating input 404 is connected to the processor 1 via the control unit 12. A correspondingly greater bandwidth and match for the spectrum, which is broader on account of the predistortion, are also provided for the downstream elements. In addition, it is expedient to design the digital/analog converters to have a relatively high resolution, in order to improve the signal-to-noise ratio in this manner. Normally, an additional resolution of one bit is sufficient in order to suppress the quantization noise to a sufficient extent.

It is also possible to use a suitable detector to detect a signal entering the output of the power amplifier 8 and to take protective measures. This can protect the power amplifier 8 against overvoltage or reflected power resulting from mismatch. The protective circuit makes it possible to reduce the electric strength of the technology used in favor of better radio frequency properties. The efficiency of the overall arrangement is significantly improved and the power transistors, particularly in the power amplifier 8, can be designed for relatively high densities.

The reflection factor of the antenna 9 or a returning signal power is measured by the directional coupler 29. This, together with the directional coupler 28, ascertains the amplitude magnitude and the phase of the waves developing between the output of the power amplifier 8 and the input of the antenna 9. By way of example, an ideal match between the power amplifier 8 and the antenna 9 produces no reflection. The directional couplers 28 and 29 then detect just one signal running from the power amplifier 8 to the antenna in the form of a wave.

If, by way of example, a metal object is now brought into the close surroundings of the antenna 9, then the latter's input impedance changes. This causes reflection of the arriving wave, whose magnitude and phase are detected by the directional couplers 28 and 29. In the case of a very great mismatch, it is possible for the largest signal component of the signal which is output by the power amplifier 8 to be reflected by the antenna 9 and to flow back into the output of the power amplifier 8 again. If the linearity response of the power amplifier as a function of the operating conditions and particularly of the load impedance is known, then it is possible to predistort the baseband signals.

In line with the invention, the ascertained amplitude and phase values of the two directional couplers 28 and 29 are transferred to the processor unit 1 via two lines. From these, the processor unit 1 ascertains the necessary predistortion coefficients, which are transferred to the predistortion unit 2. The nonlinear distortions arising in the transmission path on account of the impedance change in the antenna are compensated for. Below a particular limit power at which the amplifier 8 operates with sufficient linearity, the predistortion can be turned off. The influence of an impedance change in the antenna on the nonlinearity in the output signal from the power amplifier 8 is no longer a disturbance in such a case.

In addition, the design with directional couplers which measure the returning power allows protection of the power amplifier 8. If, by way of example, limit values are exceeded in the returning power, a protective circuit (not shown) allows the power amplifier 8 to be turned off or allows its output power to be reduced. This reduces damage as a result of reflected power. The efficiency of the overall arrangement is improved further.

The proposed arrangement may advantageously also be used in transmission stages which are designed as multiband or multimode transmission stages. Such a transmission stage permits the output of signals on various frequency bands, for example for the mobile radio standard GSM and the mobile radio standard WCDMA/UMTS. Thus, by way of example, in a saturation mode, as is provided for the GSM mobile radio standard, digital predistortion may be deactivated, while it is activated for the linear mode, such as in the case of UMTS/WCDMA, for example. In this context, it is entirely possible for the transmission stage to be designed from a plurality of amplifier trains connected in parallel, with just one amplifier train being activated and this amplifier train taking suitable measures using the predistortion unit to produce a linear signal for output.

It will be appreciated that the embodiments illustrated here may be combined in any way. In particular, it is possible for the transmission device to be designed as an integrated circuit in a semiconductor body. The transmission device achieves a significantly higher linear output power, which means that the power amplifier can be designed to be smaller. In this case, the amplifier operates continuously in a range with high efficiency. Input signals whose levels are so high that they cause distortion are predistorted in order to compensate for the nonlinearities which arise in the amplifier. The predistortion is performed by complex multiplication of the baseband signal by a complex coefficient. This also takes into account any phase distortion. In addition, only the total level of the baseband signal is used for determining the coefficient. This means that address calculation for the required coefficient is particularly simple.

The power consumption can be reduced even further if the predistortion unit is only ever activated by the control signal when the linearity of the power amplifier can no longer be observed at the currently required power without any predistortion. Examples of mobile radio standards which require active power control are WCDMA/UMTS and CDMA2000. Since the power is queried approximately 1000 times per second in that case, however, the present power and also the maximum transmission power arising are known to the processor. The processor therefore turns on the predistortion only when it is absolutely necessary and the linearity requirements are no longer observed at this power which is to be output. If predistortion is not necessary, the predistortion unit is bridged and the baseband signal provided by the processor unit is supplied to the analog/digital converters in undistorted form.

This practice is based on the fact that, in all ordinary mobile radio standards, the output power from the mobile communication appliance is adjusted by a base station at certain intervals of time if the external conditions should have altered in the process. Accordingly, the processor unit 1 knows the power which is required. Only if this is above a particular limit value, and hence digital predistortion is required, is the predistortion unit 2 activated by the control signal CONT1 from the power control regulator. As a result of suitable design of the supply for the output amplifier by connecting a DC/DC converter, various RF transfer characteristics can be selected. The DC/DC converter is usefully coupled to the power control unit 116, so that the selection is dependent on the demanded output power.

Although the invention has been shown and described with respect to a certain aspect or various aspects, it is obvious that equivalent alterations and modifications will occur to others skilled in the art upon the reading and understanding of this specification and the annexed drawings. In particular regard to the various functions performed by the above described components (assemblies, devices, circuits, units, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several aspects of the invention, such feature may be combined with one or more other features of the other aspects as may be desired and advantageous for any given or particular application. Furthermore, to the extent that the term “includes” is used in either the detailed description or the claims, such term is intended to be inclusive in a manner similar to the term “comprising.” Also, exemplary is merely intended to mean an example, rather than the best.

1. A transmission device, comprising:
a processor unit for providing a first discrete-value component (I) of a baseband signal (DAT1) at a first output and a second discrete-value component (Q) of the baseband signal (DAT1) at a second output;
a predistortion unit, operatively associated with the outputs of the processor unit, having a first and a second input and having a first and a second output,
wherein the predistortion unit has a coefficient unit for ascertaining one or more predistortion coefficients (KOEFF1), which represent complex values, on the basis of a control signal (CONT1) at a control input on the coefficient unit, a level for the first component (I), which is applied to the first input, and a level for the second component (Q), which is applied to the second input,
wherein the predistortion unit has a multiplication unit operable to output an output signal (DAT2), which is derived from the first component (I), which is applied to the first input, and from the second component (Q), which is applied to the second input, of the baseband signal (DAT1), and from the predistortion coefficient (KOEFF1), with a first discrete-value component (I2) at the first output and with a second discrete-value component (Q2) at the second output;
respective digital/analog conversion devices operatively associated with the outputs on the predistortion unit;
a modulator unit having a local oscillator input for supplying a local oscillator signal (OSC), a first input for supplying a first continuous-value signal, a second input for supplying a second continuous-value signal, which are coupled to respective outputs of the digital/analog conversion devices, and an output for outputting a complex-form output signal;
an amplification device with regulatable gain, whose input is operatively associated with the output of the modulator unit,
wherein the predistortion unit has a first and a second operating state and is configured to respectively output signals (I), (O) at the first and second outputs in the first operating state and to respectively output the first and second components (I2, Q2) of the derived output signal (DAT2) at the first and second outputs in the second operating state,
wherein the predistortion unit can be switched to the first or to the second operating state by the first control signal (CONT1) at the control input; and
a power control unit having an input for supplying a discrete-value power control signal (LS) to provide the first control signal (CONT1) at a first output and a second control signal at a second output, the first output being coupled to the control input of the predistortion unit, and the second output being coupled to a control input on the amplification device.

2. The transmission device of claim 1, wherein the first control signal (CONT1) at the first output and the second control signal at the second output of the power control unit are in the form of an identical control signal.

3. The transmission device of claim 1, wherein an output on the amplification device with regulatable gain is operatively coupled to a further amplification device which has a known gain factor.

4. The transmission device of claim 1, further comprising:
at least one sensor circuit for detecting changes in operating conditions in the transmission device and for generating signals derived therefrom at an output, the output being coupled to a second control input on the predistortion unit, where the coefficient unit is designed to ascertain the predistortion coefficient on the basis of a control signal at the second control input.

5. The transmission device of claim 3, wherein the predistortion coefficients (KOEFF1) of the predistortion unit form an inverse signal transfer function for at least one of the amplification devices located downstream of the distortion unit.

6. The transmission device of claim 1, wherein the coefficient unit for ascertaining the predistortion coefficients (KOEFF1) of the predistortion unit comprises a memory apparatus containing stored predistortion coefficients (KOEFF1) and also an address calculation unit, the address calculation unit configured to generate an address signal (ADR) for a predistortion coefficient stored in the memory apparatus from the level of the first and second components (I, Q) and from the control signal (CONT1) at the first control input, and the memory apparatus configured to provide the predistortion coefficient (KOEFF1) determined by the address signal (ADR) to the multiplication unit.

7. The transmission device of claim 1, wherein the first component (I) represents an inphase component and the second component (Q) represents a quadrature component.

8. The transmission device of claim 1, wherein the first component (I) is an amplitude and the second component (Q) is a phase.

9. The transmission device of claim 3, wherein the output of the further amplification device has a detector located downstream of it to detect an impedance change and is coupled to the processor unit for transferring the impedance change.

10. The transmission device of claim 9, wherein the detector comprises a directional coupler.

11. The transmission device of claim 9, wherein the detector detects a first amplitude magnitude and a first phase for a signal coming from the amplification device and a second amplitude magnitude and a second phase for a signal coming from a circuit downstream of the output of the amplification device.

12. The transmission device of claim 9, wherein the detector is situated between the further amplification device and an antenna.

13. The transmission device of claim 12, wherein the detector is operable to detect an impedance change in the antenna.

14. The transmission device of claim 1, wherein the predistortion unit has a filter with adjustable filter bandwidth located downstream of it, the filter comprising an actuating input which is coupled to the processor unit.

15. A method for regulating predistortion for a discrete-value signal (DAT1) in a transmission device, comprising:
multiplying first and second components (I, Q) of the signal (DAT1) by a complex predistortion coefficient (KOEFF1) when a level for an output signal from a regulatable amplification device is exceeded as determined by a control signal (CONT1), where the coefficient (KOEFF1) is dependent on respective levels of the first and second components (I, Q) of the signal (DAT1) and on a control signal (CONT1).

16. The method as claimed in claim 15, wherein the predistortion coefficient (KOEFF1) is selected from a set of stored predistortion coefficients.

17. The method of claim 15, further comprising:
ascertaining changing operating conditions in the amplification device;
deriving a signal (CONT2) from the changing operating conditions; and
using the signal (CONT2) to ascertain the predistortion coefficient (KOEFF1).

18. The method of claim 15, wherein the predistortion coefficient forms an inverse signal transfer function for the amplification device.

19. The method of claim 15, further comprising:
ascertaining an impedance change in an antenna;
deriving a signal (CONT2) from the changing impedance; and
using the signal (CONT2) to ascertain the predistortion coefficient (KOEFF1).

20. The method of claim 15, further comprising:
changing a filter from a first filter bandwidth to a second filter bandwidth during predistortion, the second filter bandwidth being larger than the first filter bandwidth.
